(19) United States
(12) Patent Application Publication
(10) Pub. No.: US 2023/0381801 A1
(43) Pub. Date: Nov. 30, 2023

(54) SPRAY DEVICE

(71) Applicant: Shenzhen Verdewell Technology Limited, Shenzhen (CN)

(72) Inventor: Bin ZHOU, Shenzhen (CN)

(21) Appl. No.: 18/319,378

(22) Filed: May 17, 2023

(30) Foreign Application Priority Data
May 31, 2022 (CN) 202221348094.8

(51) Int. Cl. B05B 11/00

(52) U.S. Cl. CPC B05B 11/0032

(57) ABSTRACT

A spray device includes: a housing; a spray head assembly; and a spray head cover. A liquid storage cavity is provided inside the housing. The spray head assembly partially protrudes from the housing and is in communication with the liquid storage cavity, the spray head assembly including a spray nozzle. The spray head cover is rotatably arranged on the housing and covers the spray head assembly, a spray hole being provided on the spray head cover. When the spray head cover is rotated to a first position, the spray hole is correspondingly in communication with the spray head assembly, and when the spray head assembly is pressed, a liquid vaporization medium in the liquid storage cavity is configured to be sprayed from the spray hole. When the spray head cover is rotated to a second position, the spray head cover covers the spray nozzle and is locked with the housing.

### CROSS-REFERENCE TO PRIOR APPLICATION

Priority is claimed to Chinese Patent Application No. 202221348094.8, filed on May 31, 2022, the entire disclosure of which is hereby incorporated by reference herein.

### FIELD

The utility model relates to the field of spray, and in particular, to a spray device.

### BACKGROUND

To use a conventional spray device, a spray head cover usually needs to be removed first. A spray head cover of a detachable design is easy to lose. A liquid vaporization medium is sprayed out from a spray head and sprayed at 90° to a spray core, which often requires a user to tilt a bottle body to spray the vaporization medium, resulting in a poor user experience. There is also a spray device without a spray head cover, which is easy to use, but it is easy to cause spray head pollution.

### SUMMARY

In an embodiment, the present invention provides a spray device, comprising: a housing; a spray head assembly; and a spray head cover, wherein a liquid storage cavity is provided inside the housing, wherein the spray head assembly partially protrudes from the housing and is in communication with the liquid storage cavity, the spray head assembly comprising a spray nozzle, wherein the spray head cover is rotatably arranged on the housing and covers the spray head assembly, a spray hole being provided on the spray head cover, wherein, when the spray head cover is rotated to a first position, the spray hole is correspondingly in communication with the spray head assembly, and when the spray head assembly is pressed, a liquid vaporization medium in the liquid storage cavity is configured to be sprayed out from the spray hole, and wherein, when the spray head cover is rotated to a second position, the spray head cover covers the spray nozzle and is locked with the housing to block the liquid vaporization medium in the liquid storage cavity from being sprayed out.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of a structure of a spray device when the spray device is opened and not pressed according to some embodiments of the utility model;

FIG. 2 is a cross-sectional view of the spray device shown in FIG. 1;

FIG. 3 is another cross-sectional view of the spray device shown in FIG. 1;

FIG. 4 is a schematic diagram of a structure of the spray device shown in FIG. 1 when the spray device is opened and pressed;

FIG. 5 is a cross-sectional view of the spray device shown in FIG. 4;

FIG. 6 is another cross-sectional view of the spray device shown in FIG. 4;

FIG. 7 is a schematic diagram of a structure of the spray device shown in FIG. 1 when the spray device is closed;

FIG. 8 is a cross-sectional view of the spray device shown in FIG. 7;

FIG. 9 is another cross-sectional view of the spray device shown in FIG. 7;

FIG. 10 is a schematic diagram of a partial structure of a housing of the spray device shown in FIG. 2;

FIG. 11 is a schematic diagram of a structure of a spray head assembly of the spray device shown in FIG. 2;

FIG. 12 is a schematic diagram of a structure of a spray head cover of the spray device shown in FIG. 2; and

FIG. 13 is a schematic diagram of a structure of a rotation mechanism of the spray device shown in FIG. 2.

### DETAILED DESCRIPTION

In an embodiment, the present invention provides an improved spray device.

In an embodiment, the present invention provides a spray device, including a housing, a spray head assembly, and a spray head cover, where
a liquid storage cavity is provided inside the housing;
the spray head assembly partially protrudes from the housing and is in communication with the liquid storage cavity; the spray head assembly includes a spray nozzle;
the spray head cover is rotatably arranged on the housing and covers the spray head assembly, a spray hole is provided on the spray head cover, when the spray head cover is rotated to a first position, the spray hole is correspondingly in communication with the spray head assembly, and when the spray head assembly is pressed, a liquid vaporization medium in the liquid storage cavity is sprayed out from the spray hole; and when the spray head cover is rotated to a second position, the spray head cover covers the spray nozzle and is locked with the housing to block the liquid vaporization medium in the liquid storage cavity from being sprayed out.

In some embodiments, the spray head assembly is rotatably connected to the spray head cover by using a rotation mechanism.

In some embodiments, the spray head assembly includes a spray head, and the rotation mechanism includes a rotating shaft; and
through holes are provided on the two opposite sides of the spray head cover; and the rotating shaft passes through the through holes and is connected to the spray head assembly for the rotation of the spray head cover.

In some embodiments, the rotation mechanism further includes a cover body arranged at the end of the rotating shaft, and the size of the cover body is greater than the size of the through hole to restrict the spray head cover from detaching from the rotating shaft.

In some embodiments, the rotating shaft is of a hollow structure with a sleeve connection at the end;
a connection structure is arranged between the rotation mechanism and the spray head;
the connection structure includes a connection positioning hole and a connection positioning column; and
the connection positioning column is arranged in the rotating shaft and extends toward the sleeve connection, and the connection positioning hole is arranged on the side wall of the spray head.

In some embodiments, a limiting structure is arranged between the rotation mechanism and the spray head; the limiting structure includes a limiting boss and a limiting notch; and
the limiting boss is arranged on the side wall of the spray head, and the limiting notch is arranged on the side wall of the rotating shaft and is arranged corresponding to the limiting boss to engage with the limiting boss.

In some embodiments, the spray head assembly includes a spray head, and the spray head includes a spray head body, and a connecting tube arranged at the end of the spray head body;
a positioning shaft is arranged at the joint between the spray head body and the connecting tube, and the positioning shaft extends toward the inner side wall of the housing; and
the rotating shaft is sleeved on the positioning shaft.

In some embodiments, a damping mechanism is arranged on the rotation mechanism.

In some embodiments, the spray head assembly includes a spray head, and the spray head includes a spray head body, and a connecting tube arranged at the end of the spray head body;
an angle greater than 90 degrees and less than 180 degrees is formed between the connecting tube and the spray head body; and the spray nozzle is arranged at the end of the spray head body away from the connecting tube.

In some embodiments, the spray head assembly includes a spray head and a spray core, the spray head is slidably sleeved on the spray core along the axial direction of the spray core, and the spray core is in communication with the liquid storage cavity.

In some embodiments, the housing includes an opening, the spray head assembly partially protrudes from the opening, and the spray head cover is rotatably arranged at the opening.

In some embodiments, a limiting guide mechanism is arranged between the spray head cover and the housing;
the limiting guide mechanism includes a guide limiting groove and a slide block; and
the guide limiting groove is arranged on the inner side wall of the housing, and the slide block is arranged on the spray head cover and slides in the guide limiting groove.

In some embodiments, the guide limiting groove includes a first guide limiting portion and a second guide limiting portion;
the first guide limiting portion extends along a pressing direction of the spray head cover, and the end of the first guide limiting portion is connected to the second guide limiting portion; and
the second guide limiting portion extends along a direction in which the spray head cover rotates relative to the housing.

In some embodiments, a limiting locking mechanism is arranged between the spray head cover and the housing;
the limiting locking mechanism includes a limiting groove, a lock block, and a lock rod;
the limiting groove is arranged on the inner side wall of the housing, and the lock block is arranged in the limiting groove; and
the lock rod is arranged on the spray head cover, slides in the limiting groove, and engages with the lock block.

In some embodiments, the housing includes an opening;
the spray head cover includes a cover portion that is rotated at the opening and covers the opening;
the cover portion includes a cover surface, and the cover surface is of a curved-surface structure; and
the spray hole is arranged on the cover portion.

In some embodiments, the spray head cover further includes connection portions arranged on the two opposite sides of the cover portion, and the connection portions protrude into the housing from the opening and are rotatably connected to the spray head assembly.

In some embodiments, an anti-slip structure is arranged on the spray head cover.

In some embodiments, an indicating structure is arranged on the spray head cover, and the indicating structure and the spray hole are arranged at an interval on a rotation track of the spray head cover to indicate the position of the spray hole.

Implementation of the spray device in the utility model has the following beneficial effects: In the spray device, a rotatable spray head cover is arranged on the housing and covers the spray head assembly. When the spray head cover is rotated to a first position, the spray hole is correspondingly in communication with the spray head assembly, and when the spray head assembly is pressed, a liquid vaporization medium in the liquid storage cavity may be sprayed out from the spray hole; and when the spray head cover is rotated to a second position, the spray head cover covers the spray nozzle and is locked with the housing, thereby blocking the liquid vaporization medium in the liquid storage cavity from being sprayed out. The spray device has advantages of a simple structure, an easy and convenient operation and a good user experience.

In order to have a clearer understanding of the technical features, the objectives, and the effects of the utility model, specific implementations of the utility model are illustrated in detail with reference to the accompanying drawings.

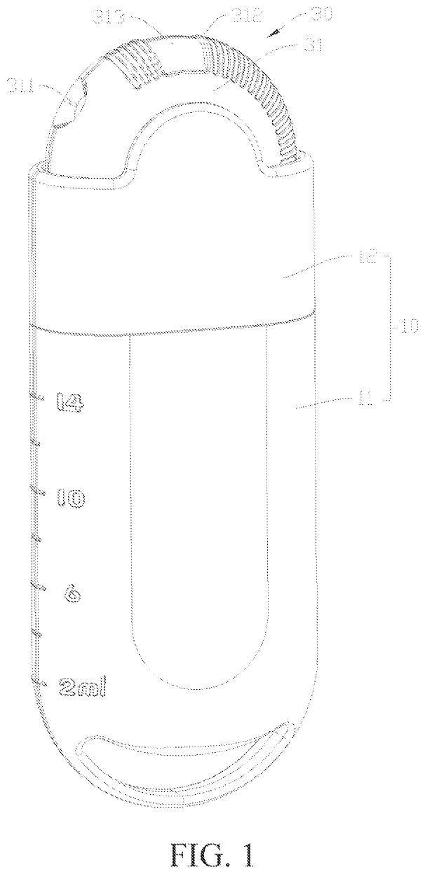

FIG. 1 shows some preferred embodiments of a spray device of the utility model. The spray device can be configured to spray a vaporization medium. The spray device has advantages of a simple structure, an easy and convenient operation and a good user experience.

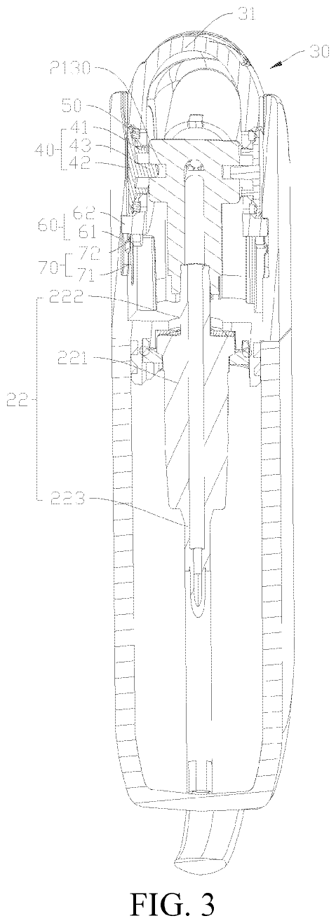

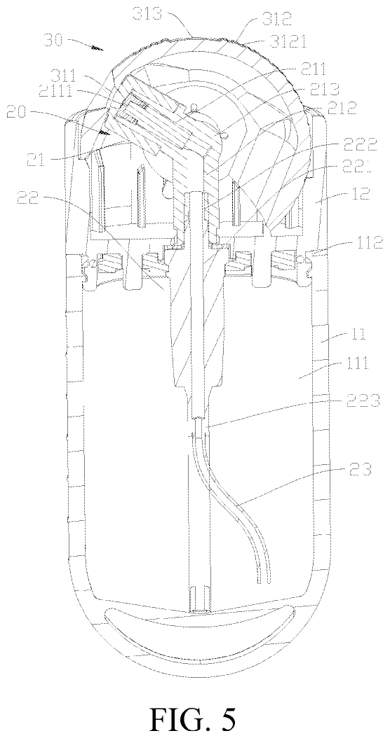

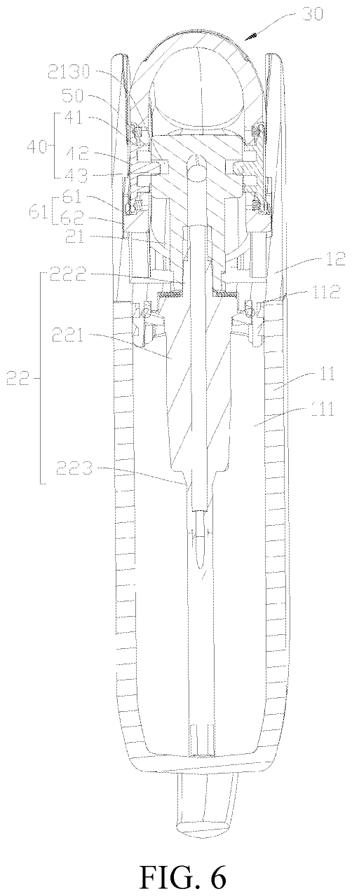

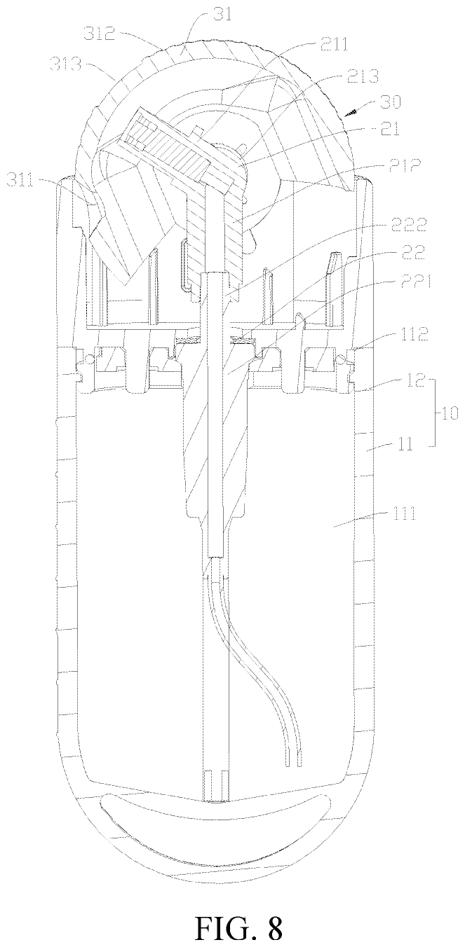

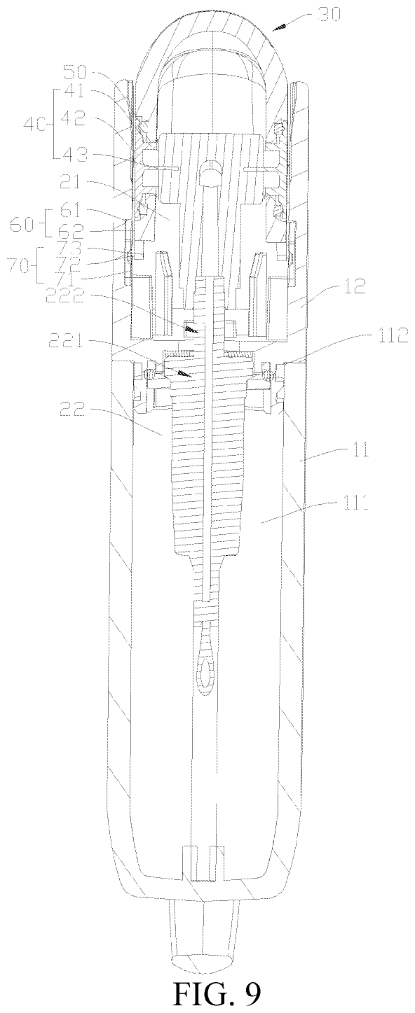

As shown in FIG. 1 to FIG. 9, the spray device includes a housing 10, a spray head assembly 20, and a spray head cover 30. The housing 10 is configured to store a liquid vaporization medium. The spray head assembly 20 partially protrudes from the housing 10 and is in communication with the liquid storage cavity 111 of the housing 10. The spray head cover 30 is rotatably arranged on the housing 10 and covers the spray head assembly 20. When spraying is required, the spray head cover 30 can be rotated to a first position, so that a spray hole 311 on the spray head cover 30 is correspondingly in communication with the spray head assembly 20, that is, the spray head assembly 20 is in an opening state, and then the spray head cover 30 is pressed to press the spray head assembly 20 so that the liquid vaporization medium in the liquid storage cavity 111 can be sprayed out. When spraying is not required, the spray head cover 30 can be rotated to a second position, so that the spray head cover 30 blocks the spray head assembly 20, and the spray head cover 30 can be locked with the housing 10, that is, the spray head assembly 20 is in a closed state, so that the spray head cover 30 cannot be pressed, thereby blocking the liquid vaporization medium in the liquid storage cavity 111 from being sprayed out and preventing a child from misoperating the spray device.

In some embodiments, the housing 10 includes a lower housing 11 and an upper housing 12. The lower housing 11 is of a flat cylindrical structure and is of a hollow structure, and a liquid storage cavity 111 can be formed on the inner side of the lower housing for storing a liquid vaporization medium. An assembly port 112 is arranged at the end of the lower housing 11, and the assembly port 112 is in communication with the liquid storage cavity 111 for assembling the upper housing 12. The upper housing 12 is detachably assembled on the lower housing 11, and the upper housing 12 is configured for installing and fixing the spray head assembly 20 and installing the spray head cover 30.

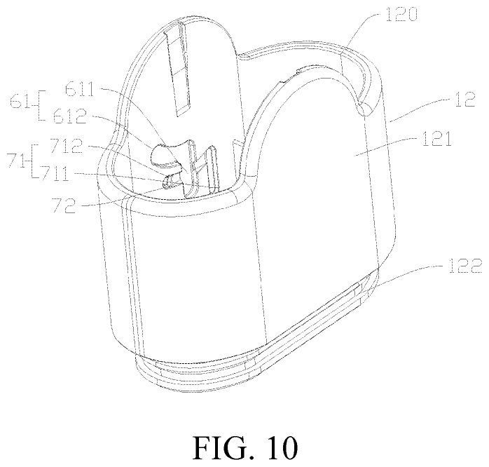

As shown in FIG. 10, in some embodiments, the upper housing 12 includes a cylindrical body 121 and a fitting portion 122. One end of the body 121 is of a hollow structure, and an opening 120 is arranged at the end. The fitting portion 122 is arranged at the end of the body 121, and can be inserted into the lower housing 11 from the assembly port 112 to be assembled with the lower housing 11. In some embodiments, the fitting portion 122 may be buckled to the lower housing 11 by using a buckling structure, such as a buckle. In some embodiments, a cross-sectional dimension of the fitting portion 122 is less than a cross-sectional dimension of the body 121.

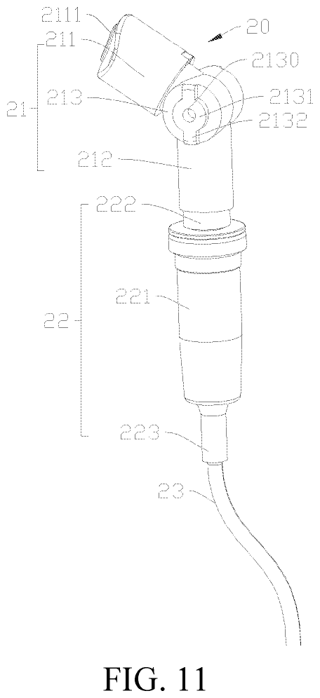

As shown in FIG. 11, in some embodiments, the spray head assembly 20 includes a spray head 21, a spray core 22, and a hose 23. The spray head 21 can be arranged in the upper housing 12 and partially protrude from the opening 120 of the upper housing 12 for spraying a liquid vaporization medium. The spray core 22 is slidably connected to the spray head 21 and can extend into the lower housing 11 for vaporizing the liquid storage cavity in a liquid storage cavity 13 and delivering the liquid vaporization medium to the spray head 21. The hose 23 is arranged in the liquid storage cavity 13 and connected to the spray core 22 for delivering the liquid vaporization medium in the liquid storage cavity 13 to the spray core 22.

In some embodiments, the spray head 21 includes a spray head body 211 and a connecting tube 212. A spray nozzle 2111 is arranged on the spray head body 211, and the end of the spray head body 211 at which the spray nozzle 2111 is arranged may protrudes from the opening 120. The connecting tube 212 is arranged at the end of the spray head body 211 away from the spray nozzle 2111 and is in communication with the spray head body 211. The connecting tube 212 can be configured to be connected to the spray core 22. In some embodiments, an angle greater than 90 degrees and less than 180 degrees is formed between the spray head body 211 and the connecting tube 212. Specifically, the angle may be 122 degrees. By setting a 122-degree elevation angle, spraying at various angles can be easily realized. In some embodiments, the connecting tube 212 can be sleeved on the spray core 22 and can be slidably arranged along the axial direction of the spray core 22, and then the spray head 21 is slidably sleeved on the spray core 22 along the axial direction of the spray core 22. When the spray head cover 30 is pressed, the spray head 21 can slide downward along the axial direction of the spray core 22, and when the spray head cover 30 is released, the spray head 21 can slide upward along the axial direction of the spray core 22 to reset. In some embodiments, a positioning shaft 213 is arranged at the joint between the spray head body 211 and the connecting tube 212. The axial direction of the positioning shaft 213 is perpendicular to the axial direction of the spray head body 211. Specifically, the positioning shaft 213 can extend toward the inner side wall of the housing 10. Specifically, the positioning shaft 213 can be installed in the rotation mechanism 40 and facilitates the rotation of the spray head cover 30.

In some embodiments, the spray core 22 includes a body 221, a first connecting tube segment 222, and a second connecting tube segment 223. The first connecting tube segment 222 and the second connecting tube segment 223 are arranged at two ends of the body 221. The body 221 can pass through the bottom wall of the upper housing 12, and part of the body 221 can penetrate into the liquid storage cavity 13. The first connecting tube segment 222 can be connected to the connecting tube 212. Specifically, the connecting tube 212 can be sleeved on the first connecting tube segment 222, and can slide along the axial direction of the first connecting tube 222. A spring can be arranged between the connecting tube 212 and the second connecting tube segment 222 to facilitate the reset of the spray head assembly 20 and the spray head cover 30. The second connecting tube segment 223 can be placed in the liquid storage cavity 13 and connected to the hose 23 in the liquid storage cavity 13.

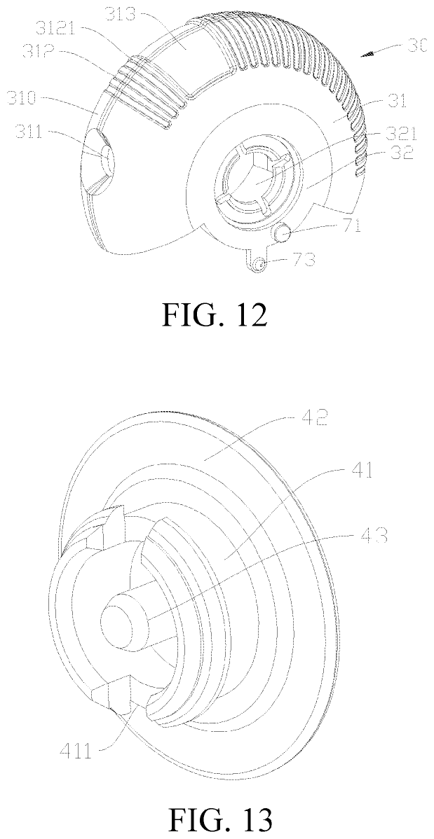

As shown in FIG. 12, in some embodiments, the spray head cover 30 includes a cover portion 31 and a connection portion 32. The cover portion 31 is rotatably arranged at the opening 120 and can cover the opening 120 by rotating. In some embodiments, the cover portion 31 may include a cover surface 310, and the cover surface 310 may be of a curved-surface structure, thereby facilitating rotation. In some embodiments, a spray hole 311 is provided on the spray head cover 30. Specifically, the spray hole 311 may be arranged at the cover portion 31 and penetrates along the thickness direction of the cover portion 31. In some embodiments, the spray hole 311 is arranged near one end of the cover portion 31. The spray hole 311 may be a circular hole. It may be understood that in some other embodiments, the spray hole 311 may not be limited to be a circular hole. In some embodiments, an anti-slip structure 312 may be arranged on the spray head cover 30. The anti-slip structure 312 can be arranged on the outer side of the cover surface 310 of the cover portion 31. The anti-slip structure 312 may be a pattern 3121, and a frictional force of the rotation of the spray head cover 30 can be increased by arranging the anti-slip structure 312. In some embodiments, an indicating structure 313 is further arranged on the spray head cover 30, and the indicating structure 313 may be a blank region arranged in the pattern 3121 of the anti-slip structure 312. The indicating structure 313 and the spray hole 311 may be arranged at an interval on a rotation track of the spray head cover 30 to indicate the position of the spray hole 311. By observing the indicating structure 313, it can be learnt that to which position the spray hole 311 is rotated, and then it can be observed whether the spray head cover 30 is rotated in place. The connection portion 32 is arranged on the two opposite sides of the cover portion 31, and forms a semi-closed cavity with the cover portion 31 through enclosure. The spray head body 211 of the spray head 21 can be inserted into the cavity. In some embodiments, the connection portion 32 can protrude into the housing 10 from the opening 120 and be rotatably connected to the spray head assembly 20. In some embodiments, through holes 321 are provided on the two opposite sides of the spray head cover 30. Specifically, the through holes 321 can be arranged on the connection portion 32. The through holes 321 can form shaft holes, and the shaft holes are arranged corresponding to the positioning shaft 213 for a rotating shaft 41 to pass through, thereby facilitating the rotation of the spray head cover 30.

As shown in FIG. 13, in some embodiments, the spray head assembly 20 is rotatably connected to the spray head cover 30 by using a rotation mechanism 40. Specifically, in some embodiments, the rotation mechanism 40 may include a rotating shaft 41, and a cover body 42. In some embodiments, the rotating shaft 41 is of a hollow structure with a sleeve connection at the end. The rotating shaft 41 can pass through the through holes 321 and be connected to the spray head assembly 20. Specifically, the rotating shaft 41 can pass through the through holes 321 and be sleeved on the positioning shaft 313, so as to facilitate the rotation of the spray head cover 30. The cover body 42 is arranged at the end of the rotating shaft 41, the size of the cover body 42 may be greater than the size of the through hole 321, so as to restrict the spray head cover 30 from detaching from the rotating shaft 41. In some embodiments, the cover body 42 may be substantially circular. In some embodiments, there may be two rotation mechanisms 40, and the two rotation mechanisms 40 may be mounted at two opposite sides of the spray head cover 30.

As shown in FIG. 11 and FIG. 13 again, in some embodiments, a connection structure is arranged between the rotation mechanism 40 and the spray head 21. The rotation mechanism 40 is connected to and fixed with the spray head 21 through the connection structure. In some embodiments, the connection structure includes a connection positioning hole 2130 and a connection positioning column 43, and the connection positioning hole 2130 is arranged on the side wall of the spray head 21. Specifically, the connection positioning hole 2130 is arranged at a central axis of the positioning shaft 213, and is arranged opposite to and coaxially with the through holes 321. A convex column 2131 may be arranged at the end of the positioning shaft 213 arranged opposite to the housing 10, the connection positioning hole 2130 is arranged at a central axis of the convex column 2131, a radial dimension of the convex column 2131 is less than a radial dimension of the positioning shaft 213, and the boss is arranged coaxially with the positioning shaft 213. The connection positioning column 43 is arranged in the rotating shaft 41, one end of the connection positioning column 43 is connected to the cover body 42, and the other end extends toward the sleeve connection. The connection positioning column 43 is arranged corresponding to the connection positioning hole 2130. When the rotating shaft 41 is sleeved on the positioning shaft 213, the connection positioning column 43 can be inserted into the connection positioning hole 2130, and then the rotating shaft 41 is connected and positioned with the positioning shaft 213.

In some embodiments, a limiting structure is arranged between the rotation mechanism 40 and the spray head 21, and the limiting structure is configured for installation and position limiting of the rotation mechanism 40 and the spray head 21. In some embodiments, the limiting structure includes a limiting boss 2132 and a limiting notch 411. The limiting boss 2132 is arranged on the side wall of the spray head 21. Specifically, there may be two limiting bosses 2132, and the two limiting bosses 2132 may be arranged at two opposite sides of the convex column 2131. The limiting notch 411 is arranged on the side wall of the rotating shaft 41 and arranged corresponding to the limiting boss 2132. When the rotating shaft 41 is sleeved on the positioning shaft 213, the limiting boss 2132 can be snapped into the limiting notch 411 to engage with the limiting notch 411 for limiting.

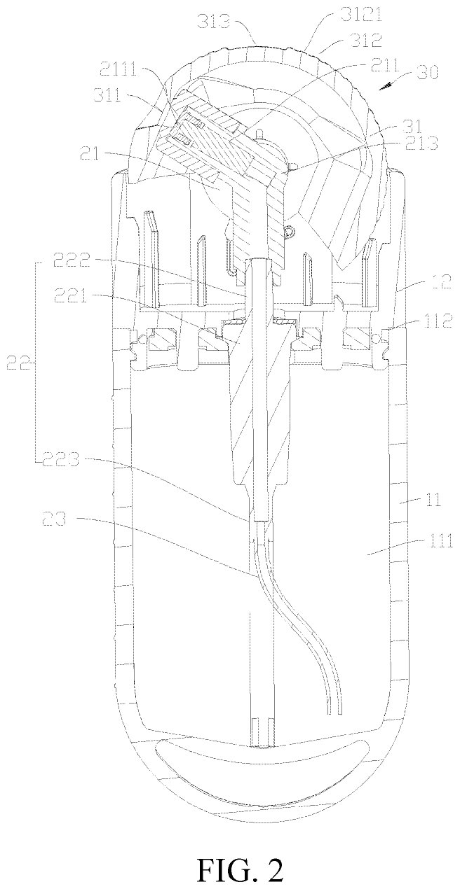

As shown in FIG. 2 again, further, in some embodiments, a damping mechanism 50 is arranged on the rotation mechanism 40. The damping mechanism 50 may be a silicone ring. The damping mechanism 50 can be sleeved on the rotating shaft 41 and abut against the cover body 42, and can abut against the connection portion 32 of the spray head cover 30 to increase rotational damping hand feeling of the spray head cover 30.

As shown in FIG. 10 and FIG. 12 again, in some embodiments, limiting guide mechanisms 60 are arranged between the spray head cover 30 and the housing 10. Specifically, the limiting guide mechanisms 60 can be divided into two groups. The two groups of the limiting guide mechanisms 60 are arranged corresponding to the two connection portions 32, and each group of the limiting guide mechanisms 60 can be arranged on the connection portion 32 and the inner side wall of the upper housing 121. In some embodiments, the limiting guide mechanism 60 includes a guide limiting groove 61 and a slide block 62. The guide limiting groove 61 is arranged on the inner side wall of the housing 10, that is, the inner side wall of the upper housing 12. The guide limiting groove 61 includes a first guide limiting portion 611 and a second guide limiting portion 612. The first guide limiting portion 611 is arranged along a longitudinal direction of the upper housing 12 and extends along the longitudinal direction of the upper housing 12, that is, along a pressing direction of the spray head cover 30 for pressing and guiding the spray head cover 30. In some embodiments, the second guide limiting portion 612 is arranged at the end of the first guide limiting portion 611. Specifically, the second guide limiting portion 612 is located at an upper end of the first guide limiting portion 611, and the end of the second guide limiting portion 612 is connected to the first guide limiting portion 611. The second guide limiting portion 612 may be an arc-shaped groove, which can extend along a circumferential direction of the upper housing 12, that is, along a direction in which the spray head cover 30 rotates relative to the housing 10, and is configured to plan a rotation track of the spray head cover 30 and guide the rotation of the spray head cover 30. The slide block 62 is arranged on the spray head cover 30. Specifically, the slide block may be a column, protruding from the outer side wall of the connection portion 32, and slidably arranged in the guide limiting groove 61.

In some embodiments, limiting locking mechanisms 70 are arranged between the spray head cover 30 and the housing 10. The limiting locking mechanisms 70 can be divided into two groups, and the two groups of the limiting locking mechanisms 70 are arranged in one-to-one correspondence with the two connection portions 32. Each group of the limiting locking mechanisms 70 is arranged on the connection portion 32 and the inner side wall of the housing 10. In some embodiments, the limiting locking mechanism 70 includes a limiting groove 71, a lock block 72, and a lock rod 73. The limiting groove 71 includes a first limiting portion 711 and a second limiting portion 712. The first limiting portion 711 and the first guide limiting portion 611 are arranged side by side and at an interval, and a distance from the first limiting portion 711 to the opening 120 is greater than a distance from the first guide limiting portion 611 to the opening 120. The first limiting portion 711 extends downward along a longitudinal direction of the upper housing 12 and is configured to press and limit the spray head cover 30. The second limiting portion 712 is arranged at the end of the first limiting portion 711 and is in communication with the first limiting portion 711. The second limiting portion is located on one side of the second guide limiting portion 62, and the second limiting portion 712 may be an arc-shaped groove extending along the circumferential direction of the upper housing 12 to limit the rotation of the spray head cover 30. The lock block 72 is arranged in the limiting groove 71. Specifically, the lock block 72 is arranged in the second limiting portion 712 and configured to engage with the lock rod 73 to lock the spray head cover 30 when the spray head cover 30 is rotated to the second position. In some embodiments, the lock block 72 is a touch feeling lock, that is, a stage arranged in the second limiting portion 712. The lock rod 73 is arranged on the spray head cover 30. Specifically, the lock rod 73 is arranged on the connection portion 32 and located below the slide block 62. The lock rod 73 and the slide block 62 are arranged in a misaligned manner and are slidable in the limiting groove 71. When the lock rod 73 slides to the lock block 72, the lock rod 73 can slide into a locked position formed between the lock block 72 and the second limiting portion 712, and then engage with the lock block 72 for locking. When the spray head cover 30 is rotated to the second position, the spray head cover 30 is locked with the housing 10, so that the spray head cover 30 cannot be pressed, that is, the spray head assembly 20 cannot be pressed to spray, so as to prevent a misoperation or an operation of a child.

As shown in FIG. 1 to FIG. 3, the spray head cover 30 is rotated to a first position. In this case, the spray device is in an opening state, and the spray hole 311 is correspondingly in communication with the spray head assembly 20. The slide block 62 slides to one end of the second guide limiting portion 612 connected to the first guide limiting portion 611, the lock rod 73 slides to one end of the second guide limiting portion 712 connected to the first limiting portion 711, and the spray head cover 30 and the spray head assembly 20 can be pressed.

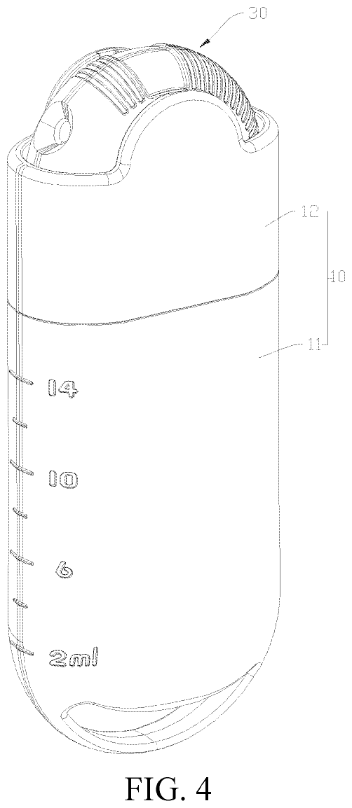

As shown in FIG. 4 to FIG. 6, the spray head assembly 20 can be pressed by pressing the spray head cover 30 from top to bottom. The slide block 62 can slide downward along the first limiting guide portion 611, and the lock rod 72 can slide downward along the first limiting portion 711, so that the liquid vaporization medium in the liquid storage cavity 13 can be sprayed out from the spray nozzle 2111 of the spray head assembly 20.

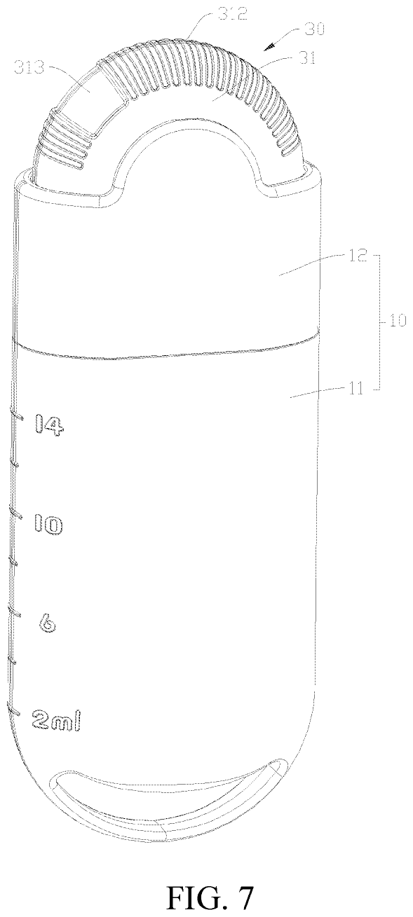

As shown in FIG. 7 to FIG. 9, the spray head cover 30 is rotated to a second position. In this case, the spray device is in a closed state, and the spray hole 311 and the spray nozzle 2111 of the spray head assembly 20 are arranged in a misaligned manner, that is, the spray nozzle 2111 of the spray head assembly 20 may be blocked by the spray head cover 30. In this case, the slide block 62 slides to one end of the second guide limiting portion 612 away from the first guide limiting portion 611, and the lock rod 73 engages with the lock block 72 to lock a position. The spray head cover 30 is locked with the housing 10, so that the spray head cover 30 cannot be pressed, that is, the spray head assembly 20 cannot be pressed, thereby preventing a misoperation and an operation of a child.

It may be understood that the foregoing embodiments only describe preferred implementations of the utility model specifically and in detail, but cannot be construed as a limitation to the patent scope of the utility model. It should be noted that, for a person of ordinary skill in the art, the foregoing technical features may be combined freely, and several transformations and improvements can be further made without departing from the idea of the utility model. These transformations and improvements all fall within the protection scope of the utility model. Therefore, any equivalent change or modification made according to the scope of the claims of the utility model shall fall within the scope of the claims of the utility model.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A spray device, comprising:
a housing;
a spray head assembly; and
a spray head cover,
wherein a liquid storage cavity is provided inside the housing,
wherein the spray head assembly partially protrudes from the housing and is in communication with the liquid storage cavity, the spray head assembly comprising a spray nozzle,
wherein the spray head cover is rotatably arranged on the housing and covers the spray head assembly, a spray hole being provided on the spray head cover,
wherein, when the spray head cover is rotated to a first position, the spray hole is correspondingly in communication with the spray head assembly, and when the spray head assembly is pressed, a liquid vaporization medium in the liquid storage cavity is configured to be sprayed out from the spray hole, and
wherein, when the spray head cover is rotated to a second position, the spray head cover covers the spray nozzle and is locked with the housing to block the liquid vaporization medium in the liquid storage cavity from being sprayed out.

2. The spray device of claim 1, wherein the spray head assembly is rotatably connected to the spray head cover using a rotation mechanism.

3. The spray device of claim 2, wherein the spray head assembly comprises a spray head, and the rotation mechanism comprises a rotating shaft,
wherein through holes are provided on the two opposite sides of the spray head cover, and
wherein the rotating shaft passes through the through holes and is connected to the spray head assembly for a rotation of the spray head cover.

4. The spray device of claim 3, wherein the rotation mechanism further comprises a cover body arranged at an end of the rotating shaft, a size of the cover body being greater than a size of the through hole to restrict the spray head cover from detaching from the rotating shaft.

5. The spray device of claim 3, wherein the rotating shaft is of a hollow structure with a sleeve connection at the end,
wherein a connection structure is arranged between the rotation mechanism and the spray head, the connection structure comprising a connection positioning hole and a connection positioning column, and
wherein the connection positioning column is arranged in the rotating shaft and extends toward the sleeve connection, and the connection positioning hole is arranged on a side wall of the spray head.

6. The spray device of claim 3, wherein a limiting structure is arranged between the rotation mechanism and the spray head, the limiting structure comprising a limiting boss and a limiting notch, and
wherein the limiting boss is arranged on a side wall of the spray head, the limiting notch being arranged on a side wall of the rotating shaft and arranged corresponding to the limiting boss to engage with the limiting boss.

7. The spray device of claim 3, wherein the spray head assembly comprises the spray head, and the spray head comprises a spray head body and a connecting tube arranged at an end of the spray head body,
wherein a positioning shaft is arranged at a joint between the spray head body and the connecting tube, the positioning shaft extending toward an inner side wall of the housing, and
wherein the rotating shaft is sleeved on the positioning shaft.

8. The spray device of claim 2, wherein a damping mechanism is arranged on the rotation mechanism.

9. The spray device of claim 1, wherein the spray head assembly comprises a spray head, and the spray head comprises a spray head body and a connecting tube arranged at an end of the spray head body,
wherein an angle greater than 90 degrees and less than 180 degrees is formed between the connecting tube and the spray head body, and
wherein the spray nozzle is arranged at an end of the spray head body away from the connecting tube.

10. The spray device of claim 1, wherein the spray head assembly comprises a spray head and a spray core, the spray head is slidably sleeved on the spray core along an axial direction of the spray core, and the spray core is in communication with the liquid storage cavity.

11. The spray device of claim 1, wherein the housing comprises an opening, the spray head assembly partially protrudes from the opening, and the spray head cover is rotatably arranged at the opening.

12. The spray device of claim 1, wherein a limiting guide mechanism is arranged between the spray head cover and the housing, the limiting guide mechanism comprising a guide limiting groove and a slide block, and
wherein the guide limiting groove is arranged on an inner side wall of the housing, and the slide block is arranged on the spray head cover and configured to slide in the guide limiting groove.

13. The spray device of claim 12, wherein the guide limiting groove comprises a first guide limiting portion and a second guide limiting portion,
wherein the first guide limiting portion extends along a pressing direction of the spray head cover, and an end of the first guide limiting portion is connected to the second guide limiting portion, and
wherein the second guide limiting portion extends along a direction in which the spray head cover rotates relative to the housing.

14. The spray device of claim 1, wherein a limiting locking mechanism is arranged between the spray head cover and the housing, the limiting locking mechanism comprising a limiting groove, a lock block, and a lock rod,
wherein the limiting groove is arranged on an inner side wall of the housing, and the lock block is arranged in the limiting groove, and
wherein the lock rod is arranged on the spray head cover, is configured to slide in the limiting groove, and configured to engage with the lock block.

15. The spray device of claim 1, wherein the housing comprises an opening;
wherein the spray head cover comprises a cover portion that is rotatable at the opening and covers the opening,
wherein the cover portion comprises a cover surface, the cover surface being of a curved-surface structure, and
wherein the spray hole is arranged on the cover portion.

16. The spray device of claim 15, wherein the spray head cover further comprises connection portions arranged on two opposite sides of the cover portion, and the connection portions protrude into the housing from the opening and are rotatably connected to the spray head assembly.

17. The spray device of claim 1, wherein an anti-slip structure is arranged on the spray head cover.

18. The spray device of claim 1, wherein an indicating structure is arranged on the spray head cover, and the indicating structure and the spray hole are arranged at an interval on a rotation track of the spray head cover to indicate a position of the spray hole.
